(19) United States
(12) Patent Application Publication
(10) Pub. No.: US 2026/0301039 A1
(43) Pub. Date: Oct. 1, 2026

(54) QUERY INTELLIGENCE ENGINE

(71) Applicant: eBay Inc., San Jose, CA (US)

(72) Inventors: Praveen Kumar BELLAM, Irving, CA (US); Mehran ELYASI, San Francisco, CA (US); Ishita Kamal KHAN, San Jose, CA (US); Chester PALEN-MICHEL, Malden, MA (US); Chih-Liang WU, San Jose, CA (US)

(21) Appl. No.: 19/374,898

(22) Filed: Oct. 30, 2025

Related U.S. Application Data
(60) Provisional application No. 63/761,805, filed on Feb. 21, 2025.

(51) Int. Cl. G06Q 30/0601; G06F 40/30; G06N 5/022

(52) U.S. Cl. CPC G06Q 30/0623; G06F 40/30; G06N 5/022

(57) ABSTRACT

Methods, systems, and computer storage media for providing a query management engine and a query intelligence engine in an item listing system are described. In operation, historical queries are accessed. Conceptual-category annotations are determined using a Large Language Model (LLM) based on semantic information associated with the historical queries. A concept summary comprising the conceptual-category annotations of the historical queries is generated based on the conceptual-category annotations. An aspect knowledge set is generated based on query-level matching and item-level matching that identify aspects associated with one or more items in an item listing platform. The concept summary is compared to the aspect knowledge set to generate a gap analysis output, the gap analysis output identifies one or more missing aspects associated with the aspect knowledge set of the item listing platform; and one or more missing aspects are incorporated into one or more features associated with the item listing platform.

### CROSS-REFERENCE TO RELATED APPLICATIONS

This application claims the benefit of U.S. Provisional Application No. 63/761,805, filed on Feb. 21, 2025. The entire contents of which are incorporated herein by reference.

### BACKGROUND

Users leverage AI to automate tasks, enhance decision-making, and optimize processes by analyzing large amounts of data and providing insights or predictions. Artificial Intelligence (AI) has become a cornerstone across multiple industries, driving innovation in various domains. AI has become a pivotal technology in modern platforms, particularly in enabling systems to process large volumes of data quickly and accurately. By leveraging advanced computational models and algorithms that replicate cognitive processes, AI can automate query handling, optimize decision-making, and improve system responsiveness. For example, AI is particularly valuable in the context of an item listing system to facilitate managing and executing queries related to product searches, user preferences, inventory data, and pricing information.

### SUMMARY

Various aspects of the technology described herein are generally directed to systems, methods, and computer storage media for, among other things, providing a query management engine designed to optimize search relevance and improve the user experience by leveraging a query intelligence engine. The query intelligence engine is designed to leverage sampled top-searched and non-converting queries from focused categories to improve search relevance. The queries are input into an LLM which annotates key concepts and categorizes them into various conceptual buckets, generating a Concept Summary from Expert (CSE). The query intelligence engine then performs query-level and item-level matching to identify and align relevant aspects between the query and e-commerce items, creating an Ecommerce Aspect Knowledge (EAK). The query intelligence engine identifies gaps between the LLM-generated aspects (CSE) and existing product attributes (EAK), revealing missing aspects. These missing aspects are incorporated into the search experience, enhancing relevance through grouped results and additional filtering options for users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A-1C are block diagrams of an artificial intelligence system for providing query intelligence management, in accordance with aspects of the technology described herein;

FIG. 2A is a block diagram of an artificial intelligence system for providing query intelligence management, in accordance with aspects of the technology described herein;

FIG. 2B is a schematic diagram for implementing an artificial intelligence system for providing query intelligence management, in accordance with aspects of the technology described herein;

FIG. 3 provides a first exemplary method of providing query management using a query intelligence engine in an artificial intelligence system, in accordance with aspects of the technology described herein;

FIG. 4 provides a second exemplary method of providing query management using a query intelligence engine in an artificial intelligence system, in accordance with aspects of the technology described herein;

FIG. 5 provides a third exemplary method of providing query management using a query intelligence engine in an artificial intelligence system, in accordance with aspects of the technology described herein;

FIG. 6 provides a block diagram of an exemplary artificial intelligence system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platforms or item listing platforms such as EBAY content platform, developed by EBAY INC., of San Jose, California.

Item listing systems employ query management for optimizing how users interact with and find relevant listings within these platforms. Query management functionality involves the systems and processes designed to optimize the execution and relevance of user search queries across various platforms. It typically includes the stages of query processing, query refinement, ranking, and result retrieval. This process aims to deliver the most relevant and timely information by leveraging data about user behavior, search patterns, and historical queries. Traditional query management systems utilize keyword matching, ranking algorithms, and basic relevance scoring to present search results. More advanced systems integrate user feedback, personalization, and context to fine-tune results dynamically. Effective query management plays a crucial role in enhancing user experience by making searches faster, more relevant, and tailored to individual needs.

An item listing system may also provide generative-AI-supported applications (“generative AI applications”) that leverage generative AI models (e.g., Large Language Models—“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various tasks across different domains to provide improvement in automation, efficiency, and human-like interaction. Item listing systems are beginning to integrate AI to streamline search and improve user interactions by analyzing vast amounts of user and product data. AI enhances these systems by enabling smarter categorization, better personalization, and more accurate recommendations, ultimately improving the efficiency and relevance of product searches.

Conventional search systems are limited in their ability to dynamically understand and map user queries to relevant product aspects, often resulting in less accurate search results and a suboptimal user experience. These systems often lack effective mappings to critical semantic concepts, which impedes their ability to fully comprehend the intent behind user queries. Additionally, the absence of automated mechanisms for dynamic vocabulary enhancement exacerbates this issue. The failure to capture essential buyer query attributes or relevant concepts results in suboptimal search outcomes, manifesting as irrelevant product recommendations, insufficient inventory visibility, or inadequate navigation options, ultimately diminishing the user experience. For instance, a user starts by searching for “laptops” but refines their query to “laptops with long battery life.” If the search system doesn't adapt to this change, it might still show irrelevant results, like high-performance gaming laptops, which don't match the user's needs. This causes the user to refine their query again, leading to a frustrating experience and potentially abandoning the search altogether due to the time wasted. As such, a more comprehensive query management engine—with an alternative basis for providing query management functionality—can improve computing operations and interfaces for search systems including item listing systems.

### Description of Technical Solution

At a high level, a query management engine is provided to optimize search relevance and improve the user experience by leveraging a query intelligence engine. The query intelligence engine begins with identification of underperforming search queries, which are extracted from e-commerce search logs based on predefined criteria. These queries are selected by analyzing impression counts, click-through rates, and conversion rates to pinpoint searches that yield high traffic but low engagement. Once the problematic queries are identified, they are processed using a fine-tuned Large Language Model (LLM) capable of extracting conceptual annotations beyond the platform's structured taxonomy. The LLM is designed to categorize query elements into general product attributes, niche-specific details, and trend-based influences, ensuring that it captures both standard product aspects and contextual variations that could enhance search accuracy.

After the LLM generates its conceptual output, the query intelligence engine compares these extracted attributes against the platform's structured product metadata, known as the E-commerce Aspect Knowledge (EAK) database. This structured taxonomy, typically built on predefined attributes and categories, serves as the foundation for filtering and search functionality but often lacks the flexibility needed to adapt to user intent. To bridge this gap, the implementation employs a mapping and enrichment engine that aligns LLM-generated concepts with existing structured attributes. This process utilizes multiple techniques, including exact string matching for direct comparisons, synonym resolution to account for variations in terminology, and machine learning-based similarity models, such as embedding-based approaches, to evaluate the semantic closeness of different aspect labels.

Once the mapping process is complete, the query intelligence engine identifies discrepancies between the LLM-generated annotations and the structured taxonomy. These discrepancies highlight missing aspects that are either absent from the database or improperly classified. Missing aspects are categorized into two groups: those that are entirely new and not represented in the e-commerce taxonomy, and those that exist but are not effectively integrated into search results. The identified missing attributes are then incorporated into the search system through a dynamic enrichment process that enhances product discoverability. This is achieved by expanding filtering options, refining search categorization, and improving query understanding, ensuring that users are presented with more relevant results.

To integrate these improvements into the search experience, the enriched metadata is applied to search results through structured enhancements. New filtering options are introduced, allowing users to refine searches based on the newly identified attributes, while existing filters are adjusted to better align with actual user intent. Additionally, the Organized Search Results (OSR) module is updated to group products more effectively based on enriched attributes, facilitating a more intuitive browsing experience. The overall system operates in a continuous feedback loop, monitoring search performance and user interactions to refine the LLM model and improve future mappings. By automating the detection and integration of missing aspects, the solution ensures a scalable and adaptable approach to e-commerce search optimization, dynamically evolving with shifting consumer trends and preferences.

By way of example, query intelligence engine is configured to identify and address missing aspects in an e-commerce search query. The query intelligence engine can operate on real-world product searches employing LLM-generated annotations that are compared against structured e-commerce platform metadata to uncover gaps. Operationally, the query intelligence engine, in one example, processes a set of problem queries sampled from fashion and home & garden categories. These queries are selected based on performance metrics such as high impression counts but low conversion rates. The dataset can be derived from non-converting search queries between a predefined period of time ensuring that the model focuses on areas where search optimization is needed the most.

Once the problematic queries are identified, they are processed using a fine-tuned LLM, which generates structured conceptual annotations. The LLM categorizes aspects into multiple conceptual buckets, such as:
Product Characteristics (e.g., “product type,” “brand,” “material”)
Usage and Demographics (e.g., “occasion,” “gender,” “price range”)
Design and Customization (e.g., “customization options,” “regional styles”)
Influences and Trends (e.g., “celebrity endorsements,” “fashion trends”)
Value and Collectibility (e.g., “collector value,” “limited editions”)

For example, if a user searches for “Vintage leather messenger bag for men”, the LLM-generated Concept Summary (CSE) might extract:
General Concepts: Messenger Bag, Leather, Men, Vintage
Niche Concepts: Customization (Monogram Engraving), European Vintage
Trends & Cultural Influences: Retro Aesthetic, Luxury Appeal

Next, these LLM-generated aspects are compared against the e-commerce platform's structured metadata (E-commerce Aspect Knowledge, EAK), which consists of predefined product attributes. It is contemplated that while attributes like “Leather” and “Men's” exist in an e-commerce platform taxonomy, aspects such as “Vintage” might be misclassified under “Casual”, and “Monogram Engraving” might be missing entirely.

The mapping process uses a combination of string matching, synonym recognition, and semantic similarity models to align LLM-generated aspects (CSE) with the e-commerce platform's structured aspects (E_CSE). However, when a direct match is not found, the system flags missing aspects. In this case:
“Vintage” is misclassified and not properly mapped as a style option.
“Monogram Engraving” does not exist as a filter, limiting customization visibility.
“Retro Aesthetic” is missing, despite being a relevant consumer trend.

The query intelligence engine further supports integrating missing aspects into search results. The query management engine updates search filters to include newly identified attributes and refines search categorization to ensure users find more relevant results. The query intelligence engine improves user engagement, ensuring that previously non-converting queries become more effective in surfacing relevant inventory. In this way the query intelligence engine improves search accuracy by addressing gaps in structured e-commerce taxonomies while adapting to real-time user behavior and emerging trends.

### Example System and Resources

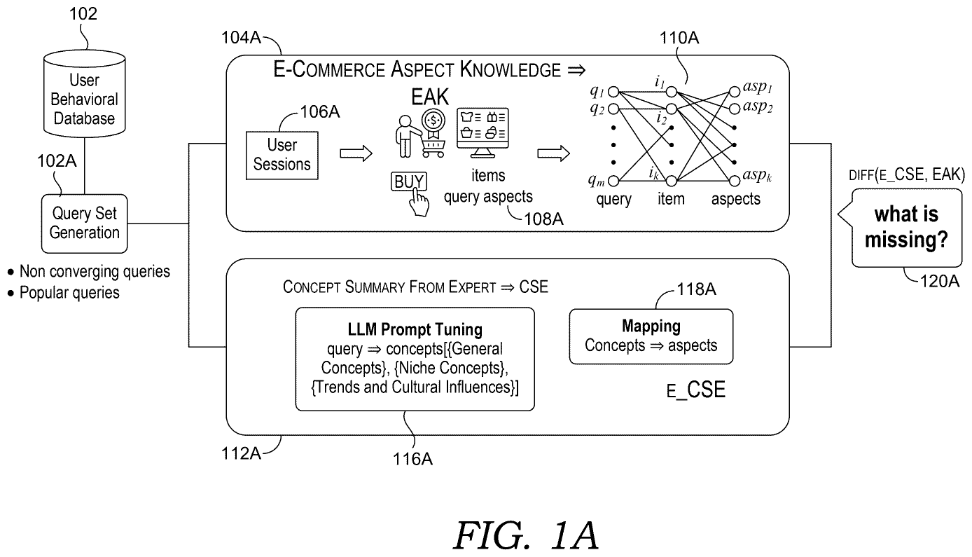

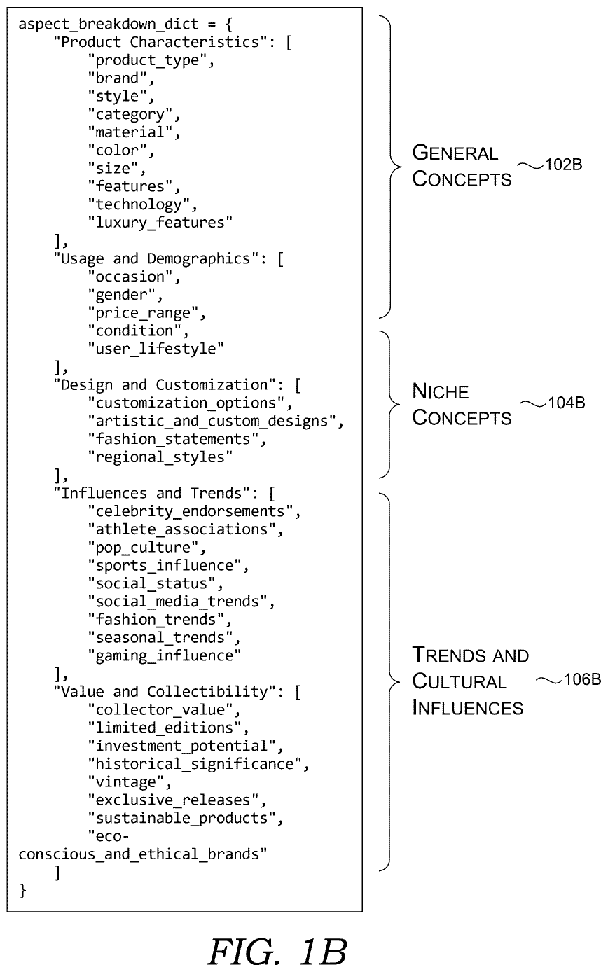

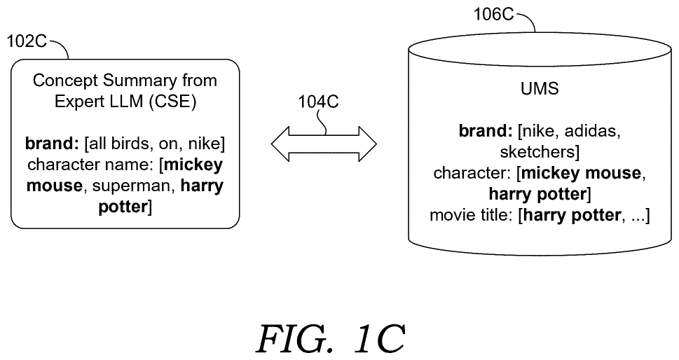

Aspects of the technical solution can be described by way of examples and with reference to FIG. 1A-1C.

FIG. 1A illustrates the end-to-end architecture of the query intelligence engine for identifying and addressing missing aspects in e-commerce search queries using a Large Language Model (LLM). The process begins with query set generation 102A which extracts a focused set of queries from a user behavioral database 102. These include non-converting queries (those with low engagement) and popular queries (those with high impressions but potentially poor results), providing the basis for analysis.

The query intelligence engine then branches into two complementary workflows. The top workflow represents the E-commerce Aspect Knowledge (EAK) pipeline 104A. The EAK pipeline 104A accesses user session data 106A—drawn from historical search and engagement patterns—and associates the user session data 106A with items with query aspects 108A. This results in output (i.e., EAK 110A) that is structured metadata about how items are tagged with aspects (e.g., brand, color, size) in relation to queries. The EAK 110A can be visualized as connections between queries, items, and associated aspects forming the EAK layer of structured product knowledge based on existing taxonomy.

In parallel, the bottom workflow represents Concept Summary from Expert (CSE) pipeline 112A. CSE pipeline 112A captures CSE insights through LLM Prompt Tuning 116A. The LLM processes each query and generates a rich set of conceptual annotations, grouped into three major buckets: General Concepts, Niche Concepts, and Trends & Cultural Influences. These concept-level insights (i.e., CSE 118A) reflect a broader understanding of user intent that extends beyond the platform's structured vocabulary. The CSE 118A output is then mapped to existing e-commerce aspects creating the E_CSE 120A, which is the subset of LLM-generated concepts that can be aligned with known structured metadata.

Finally, the outputs of both branches (i.e., EAK 110A and CSE 118A) are compared to calculate the difference between them, denoted as DIFF(E_CSE, EAK) 120A. This comparison answers the core question, “What is missing?”, by identifying aspects that are either not captured in the structured metadata or not surfaced during search. These missing aspects can then be incorporated into the e-commerce system to enrich filtering options, improve query matching, and enhance the overall search experience.

With reference to FIG. 1B, FIG. 1B illustrates an exemplary internal structure of the conceptual annotation framework used by a Large Language Model (LLM) to interpret user search queries in the query intelligence engine. It shows how extracted concepts are organized into a structured dictionary called aspect_breakdown_dict, which categorizes product-related attributes into semantically meaningful buckets. These buckets reflect the LLMs understanding of how shoppers describe, seek, and evaluate products, and play a critical role in enriching the search experience by extending beyond the constraints of structured e-commerce taxonomies.

Before generating the structured concept buckets shown in FIG. 1B, the LLM was instruction fine-tuned using a few-shot approach. In this step, the model was presented with a small number of representative queries and their detailed conceptual annotations, which served as templates for how to break down future queries. These examples taught the LLM not only which types of concepts to identify but also how to organize them into a consistent structure. As a result, the LLM learned to output a structured dictionary—shown in FIG. 1B as aspect_breakdown_dict—that categorizes concepts into semantically meaningful groups.

The first category, labeled General Concepts 102B, includes fundamental product descriptors under subgroups like “Product Characteristics” and “Usage and Demographics.” These consist of attributes such as product_type, brand, style, material, price_range, gender, and user_lifestyle. These are core attributes typically found in most product listings and map well to existing structured taxonomies (e.g., Unified Metadata System (UMS)). Their inclusion allows the LLM to capture essential search dimensions that are already well-supported by e-commerce systems.

The second category, labeled Niche Concepts 104B, includes more specialized descriptors grouped under “Design and Customization.” These attributes—such as customization_options, regional_styles, fashion_statements, and artistic_and_custom_designs—represent dimensions that are less commonly structured in traditional e-commerce databases. By identifying these concepts, the query intelligence engine gains the ability to surface unique or differentiated product characteristics that are often underrepresented, thereby enriching the user's ability to explore diverse preferences.

The third and final category, Trends and Cultural Influences 106B, expands the conceptual understanding to include culturally and socially driven attributes found under “Influences and Trends” and “Value and Collectibility.” These include concepts like celebrity_endorsements, fashion_trends, social_media_trends, vintage, limited_editions, and eco-conscious_and_ethical_brands. These aspects are vital for recognizing emerging consumer behaviors and values that influence purchase decisions but are rarely embedded in fixed product taxonomies.

The query intelligence engine supports concept extraction enabled by the LLM. By organizing query insights into general, niche, and cultural categories, the query intelligence engine ensures that both standard and previously overlooked aspects are accounted for. This classification is central to identifying missing or unmapped attributes, which are later compared against structured e-commerce aspects to improve search recall, product discovery, and customer experience.

With reference to FIG. 1C, FIG. 1C illustrates the mapping process at the heart of the query intelligence engine, showing how LLM-generated concepts (CSE) are aligned with the existing structured e-commerce taxonomy (UMS) to create a unified understanding of product attributes. On the left, the Concept Summary from Expert (CSE) LLM 102C contains conceptual annotations extracted from a search query. These include user-facing descriptors such as brand and character name, with values like all birds, on, nike, mickey mouse, superman, and harry potter. These are generated by the LLM based on the language and context of the user's query and may not conform exactly to the platform's internal naming or categorization standards.

On the right, the Unified Metadata System (UMS) 106C represents the structured vocabulary used by the e-commerce platform to define valid aspect names and values across listings. For instance, the UMS lists recognized brand values such as nike, addidas, and sketchers, and character values like mickey mouse and harry potter. Importantly, it includes a movie title field that also contains harry potter, illustrating that certain values may exist under multiple aspect types depending on their context.

The bi-directional arrow 104C between CSE and UMS signifies the mapping engine responsible for aligning LLM outputs with platform-specific metadata. This involves several techniques, including:
Exact string matching (e.g., nike matches directly),
Partial value mapping based on shared values (e.g., harry potter under character name in CSE matches character and movie title in UMS),
Heuristic or embedding-based similarity matching when names don not align perfectly (e.g., resolving all birds or on to valid brand entries if possible).

This mapping is critical for transforming free-form, LLM-generated concepts into structured aspects that the platform's search engine can use. It enables the system to reconcile natural language expressions with rigid taxonomies, facilitating the detection of missing aspects (when CSE values have no structured match) and improving the overall completeness and precision of search results. FIG. 1C, therefore, visualizes the essential bridge between unstructured user intent and structured e-commerce data that underpins the entire solution.

By way of example, to map LLM-generated concepts to structured product aspects in a typical e-commerce platform, the first step is to reliably parse the LLM output. While the model may be prompted to return JSON-formatted annotations. Once parsed, the next step is to align the LLM-generated aspect names with the platform's existing aspect taxonomy. This presents a challenge, as the LLM may generate intuitive, user-friendly names like “product type” or “character name,” whereas the platform's structured data might use simpler or differently worded labels such as “type” or “character.”

To perform this mapping, the query intelligence engine can use the platform's aspect dictionary, which includes standardized aspect names and lists of associated values. The process begins with direct string matching between the LLM-generated aspect names and those in the dictionary. If no exact match is found, the system looks at the values under each aspect. For each LLM-generated aspect, it checks which predefined aspect shares the most matching values.

For example, suppose the LLM produces:
brand: [all birds, on, nike]
character name: [mickey mouse, superman, harry potter]

And the platform's structured aspect dictionary includes:
brand: [nike, addidas, sketchers]
character: [mickey mouse, harry potter]
movie title: [harry potter, . . . ]

Here, “brand” maps directly by name and includes overlapping values like “nike.” But “character name” does not have an exact match in the platform's taxonomy. However, several of its values—like “mickey mouse” and “harry potter”—are listed under the structured aspect “character.” Since “character” contains more overlapping values than alternatives like “movie title” (which includes only “harry potter”), the system maps “character name” to “character.”

This approach allows the query intelligence engine to resolve semantic mismatches between natural language terms produced by the LLM and formal labels defined in the platform's structured metadata, making it easier to integrate LLM-driven insights into the product discovery experience.

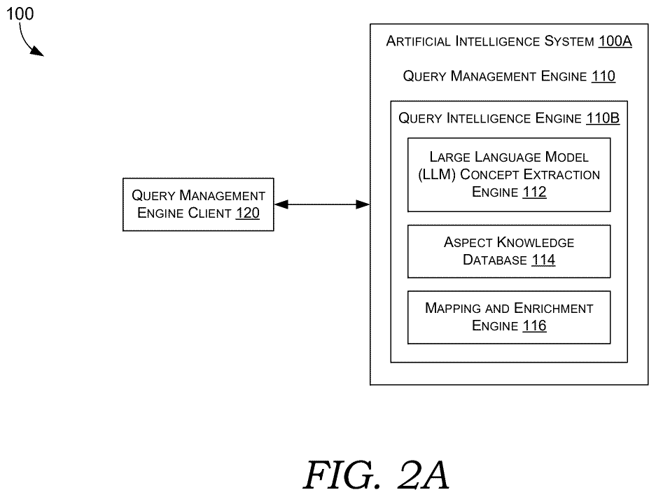

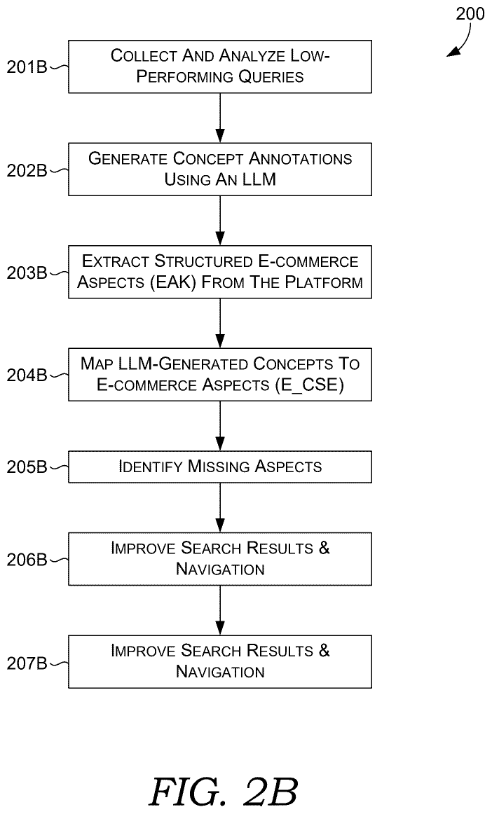

With reference to FIG. 2A, FIG. 2A illustrates cloud computing system 100 (e.g., of an item listing system) including artificial intelligence (AI) system 100A, query management engine 110, query intelligence engine 110B including Large Language Model (LLM) concept extraction engine 112 aspect knowledge database 114, and mapping and enrichment engine 116; and query management engine client 120.

LLM concept extraction engine 112 serves as the intelligent processing engine that interprets user search queries beyond the limitations of structured databases. It analyzes natural language input and generates conceptual annotations, categorizing them into general product attributes, niche aspects, and trend-based influences. LLM concept extraction engine 112 allows the query intelligence engine to capture user intent more holistically, recognizing synonyms, contextual variations, and emerging consumer trends that traditional taxonomies might miss.

Aspect knowledge database 114 represents the structured metadata repository used by the e-commerce platform to classify and filter products. Aspect knowledge database contains predefined aspect names and values (e.g., “Material: Leather” or “Style: Casual”), which serve as the foundation for product categorization. Aspect knowledge database component ensures that product listings are searchable and navigable, but it often lacks flexibility, making it necessary to integrate LLM-generated insights to fill missing gaps in query understanding.

Mapping and enrichment engine 116 acts as the bridge between the LLM-generated concepts and the structured e-commerce metadata. Mapping and enrichment engine 116 compares and aligns extracted concepts with existing database attributes, using techniques like exact string matching, synonym resolution, and machine learning-based semantic similarity. Mapping and enrichment engine 116 then identifies missing aspects and updates the search system to enhance filtering options, refine query interpretation, and improve product discoverability. By automating metadata augmentation, this engine ensures a dynamic and scalable approach to search optimization.

For clarity and efficient reference, a glossary of key terms and concepts pertinent to the technical solution associated with a query intelligence engine is provided below.
Large Language Model (LLM)—A machine-learning model trained on vast amounts of text to understand and generate language-based insights. In this system, the LLM is used to extract conceptual annotations from search queries, allowing the identification of key product characteristics that may not be explicitly defined in structured e-commerce taxonomies.
Concept Summary from Expert (CSE)—The structured output generated by the LLM that categorizes a search query into conceptual buckets such as product type, material, style, customization options, and social trends. CSE helps to enrich search queries by capturing attributes that structured databases may lack.
Conceptual-Category Annotations—These are labels generated from natural language inputs—such as search queries—that classify terms into semantic groups like product characteristics, user demographics, or cultural trends. These annotations enable systems to interpret user intent more broadly by capturing implicit or unstructured information beyond predefined taxonomies or fixed metadata schemas. A conceptual-category annotation is a label assigned to key concepts from the historical queries that support categorizing the historical queries into specific semantic groups.
E-commerce Aspect Knowledge (EAK)—The set of structured product attributes used in an e-commerce platform to define and categorize inventory. EAK consists of attributes like brand, color, material, and size, but may lack certain niche or emerging concepts that are relevant to user intent.
Top-Searched Query—These user-entered search phrases that appear with high frequency within a given time frame on an online platform. These queries indicate popular user interests or demand patterns and are often analyzed to optimize search relevance, inventory visibility, and user experience on e-commerce or content platforms.
Unified Metadata System (UMS)—A centralized taxonomy of product attributes and values used for product categorization in an e-commerce platform. The system matches LLM-generated concepts to existing structured attributes, allowing for better alignment between search queries and product listings.
Query-Level and Item-Level Matching—A process in which search queries and product listings are analyzed to extract relevant product aspects. Query-level matching associates user input with existing structured metadata, while item-level matching ensures products contain appropriate aspects to enhance search relevance.
Missing Aspect Identification—The process of comparing LLM-generated aspects (CSE) with structured e-commerce aspects (EAK) to detect gaps. These gaps indicate attributes that could improve search relevance, such as missing product styles, customization options, or trend-based attributes.
Instruction Fine-Tuning—A technique used to train an LLM on specific examples to improve its performance in generating structured annotations. This method refines the model's ability to categorize product aspects into predefined conceptual buckets, improving the quality of the generated Concept Summary from Expert (CSE).
eBERT Model for Aspect Matching—A machine learning-based semantic matching system that aligns LLM-generated concepts with structured e-commerce aspects by evaluating text similarity. It helps resolve differences in terminology, such as mapping “product type” (CSE) to “type” (EAK) through contextual similarity.
Organized Search Results (OSR) Module—A feature on the Search Results Page (SRP) that groups product listings based on shared attributes. By integrating newly identified aspects from LLM-generated concepts, the OSR module improves navigation and filtering, making search results more relevant.
Query Intelligence-Based Filtering Option—This dynamic filter generated in response to a user query by analyzing its inferred meaning, including aspects not explicitly present in structured data. It leverages semantic interpretation—often via machine learning or LLMs—to surface relevant, context-aware filters beyond the platform's predefined attribute set.
Core Filtering Option—This is a predefined, static filter derived from structured product attributes in the platform's taxonomy (e.g., brand, size, color). These filters are consistently available across similar item listings and are based on metadata explicitly tagged within the platform's database, enabling standard navigation and refinement of search results.
E_CSE (E-commerce mapped Concept Summary from Expert)—The refined set of LLM-generated concepts that have been successfully mapped to the e-commerce taxonomy (EAK). E_CSE represents the overlap between world knowledge (LLM-generated aspects) and structured marketplace attributes, providing a more complete search experience.

With reference to FIG. 2B, FIG. 2B, illustrates a schematic 200 associated with providing a query management in accordance with embodiments described herein. The implementation of the query intelligence engine follows a structured step-by-step process designed to improve search efficiency and user experience. Each step contributes integrating Large Language Models (LLMs) with existing structured e-commerce databases to support product discovery. The technical solution of the query intelligence engine can be explained by way of steps and an example query intelligence implementation.

Step 201B: Identifying Low-Performing Queries-The process begins by selecting search queries that receive high impressions but result in low engagement or conversion rates. These queries indicate that users are searching for products but not finding relevant results, suggesting that the platform's structured search lacks the necessary understanding of these queries.

To define this problem query set, search logs are analyzed based on the following criteria:
The query must have been searched more than 10 times (high impression count).
The click-through rate (CTR) must be less than 10%, indicating poor engagement.
The top 3,000 underperforming queries are selected for deeper analysis.

By identifying these problematic queries, the system can focus on improving search relevance where it matters most.
Step 202B: Extracting Conceptual Information Using an LLM—Once the problem query set is established, each query is processed using a Large Language Model (LLM) that has been fine-tuned to extract rich semantic information beyond the platform's predefined taxonomy. The goal is to obtain a more comprehensive conceptual understanding of user intent.

The LLM annotates each query by categorizing relevant concepts into three main groups:
General Concepts—Basic product attributes such as type, material, brand, and price range.
Niche Concepts—More specific product characteristics, including customization options, regional variations, and style preferences.
Trends & Cultural Influences—Aspects influenced by consumer trends, social media, celebrity endorsements, and seasonal factors.

For example, if a user searches for “Vintage leather messenger bag for men”, the LLM generates the following structured breakdown:
General Concepts: Product Type (Messenger Bag), Material (Leather), Gender (Men's), Style (Vintage)
Niche Concepts: Customization (Monogram Engraving), Regional Style (European Vintage)
Trends & Cultural Influences: Fashion Trend (Retro Aesthetic), Social Status (Luxury Appeal)

This LLM-driven annotation process provides a deeper, more flexible interpretation of search intent.
Step 203B: Retrieving Existing E-commerce Aspects—To compare the LLM-generated concepts with structured e-commerce data, the system queries the Unified Metadata System (UMS)—a database of predefined product attributes used for filtering and categorization.

Each product listing in the marketplace is associated with structured aspects (also known as e-commerce aspect knowledge (EAK)). These aspects define how a product is categorized and discovered within the platform's search system.

For instance, for the “Vintage leather messenger bag for men” query, the UMS might return:
Product Type: Bag
Material: Leather
Gender: Men's
Style: Casual

This comparison helps determine which aspects are already accounted for and which might be missing from the structured database.
Step 204B: Mapping LLM Concepts to Structured E-commerce Aspects—After extracting both LLM-generated concepts (CSE) and structured e-commerce aspects (EAK), the next step is to map them together to identify alignment and discrepancies.

The system first attempts direct string matching to check if concepts from the LLM exist in the e-commerce database. If an exact match is unavailable, the system applies synonym recognition and semantic similarity techniques, including:
Value comparison—Checking whether the LLM-generated values (e.g., “Messenger Bag”) align with structured attributes (e.g., “Bag”).
Text embeddings (eBERT model)—Using deep learning models to assess the contextual similarity between aspect names.

For example, in the case of our vintage leather messenger bag query:
“Leather” is directly matched as a material.
“Messenger Bag” is matched to the broader category “Bag”.
“Men” is aligned with “Men's”.
“Vintage”, however, is incorrectly mapped to “Casual”, showing a mismatch that needs correction.

This mapping process ensures that structured aspects are properly enriched with LLM-driven insights.
Step 205B: Identifying Missing Aspects—By comparing the LLM-generated concepts (CSE) and the mapped structured aspects (E_CSE), the system identifies missing aspects that could improve search accuracy.

There are two primary types of missing aspects:
Missing Concepts—Attributes that the LLM identified but that have no equivalent representation in the e-commerce taxonomy.
Missed E-commerce Aspects—Existing e-commerce aspects that should be present but are missing in the search query results.

For instance, in the vintage leather messenger bag query:
“Vintage” is missing or misclassified, preventing users from filtering by vintage style.
“Monogram Engraving” (a niche customization aspect) is completely absent, meaning shoppers looking for personalized options won't find relevant listings.
“Retro Aesthetic” (a trend-based aspect) is unrecognized, even though it might drive purchase decisions.

These missing aspects highlight gaps in the current search system that need to be addressed.
Step 206B: Enhancing Search and Navigation—Once missing aspects are identified, they can be integrated into the e-commerce platform to improve search relevance and user experience. This can be done in several ways:
Expanded Filtering Options: Missing attributes such as “Vintage Style” or “Monogram Engraving” are added as new filters on the Search Results Page (SRP).
Improved Query Understanding: If a user searches for “vintage bag,” the system ensures that “Vintage” is correctly mapped to the style attribute rather than ignored.
Organized Search Results (OSR) Module: Listings are dynamically grouped based on newly discovered aspects, making browsing more intuitive.

These enhancements make search more intuitive, personalized, and effective, improving product discoverability.
Step 207B: Continuous Learning and System Optimization—The final step involves monitoring the impact of the improved search system and making ongoing refinements.

Performance metrics such as click-through rates, conversion rates, and user engagement are tracked to assess improvements. The LLM model is periodically retrained with new data to refine its conceptual annotations. Additional techniques such as better JSON formatting for structured outputs and refined text similarity matching are implemented to enhance accuracy. By continuously refining the system, the platform ensures that search accuracy and product discovery remain optimized over time.

By way of example,

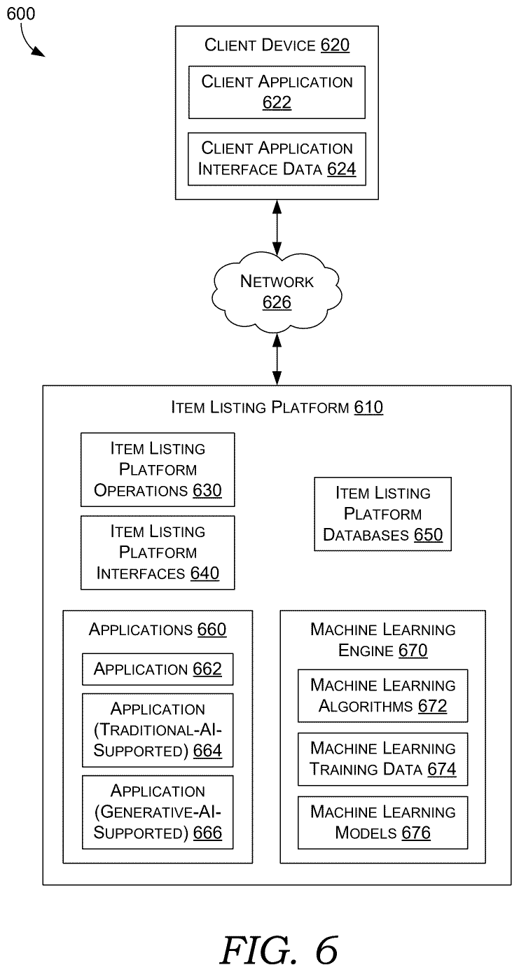

Aspects of the technical solution can be described by way of examples and with reference to FIG. 1A-1C and 2A-2B. FIG. 2A is a block diagram of an exemplary technical solution environment, based on example environments described with reference to FIGS. 6, 7, and 8 for use in implementing embodiments of the technical solution are shown. Generally the technical solution environment includes a technical solution system suitable for providing the example item listing system 600 in which methods of the present disclosure may be employed. In particular, FIG. 2A shows a high-level architecture of the cloud computing system 100 in accordance with implementations of the present disclosure. Among other engines, managers, generators, selectors, or components not shown (collectively referred to herein as “components”), the cloud computing system 100 of FIG. 2A support functionality described in FIG. 1A-1C.

### Example Methods

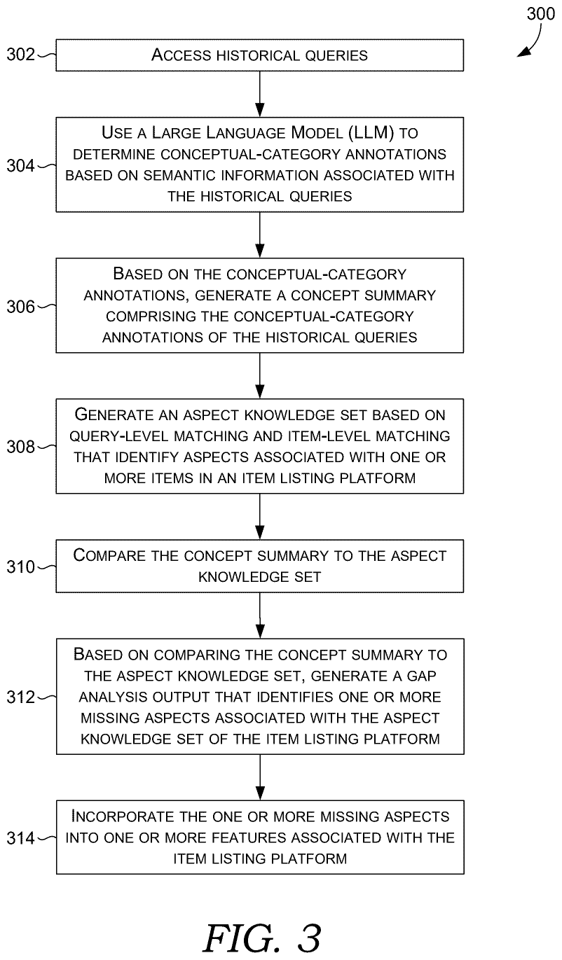

With reference to FIGS. 3, 4, and 5 flow diagrams that illustrate methods for providing a query management engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in an artificial intelligence system (e.g., computerized system or computer system).

Turning to FIG. 3, a flow diagram is provided that illustrates a method 300 for providing alternate query generation in an artificial intelligence system. At block 302, access historical queries. At block 304, using a Large Language Model (LLM), determine conceptual-category annotations based on semantic information associated with the historical queries. At block 306, based on the conceptual-category annotations, generate a concept summary comprising the conceptual-category annotations of the historical queries. At block 308, generate an aspect knowledge set based on query-level matching and item-level matching that identify aspects associated with one or more items in an item listing platform. At block 310, compare the concept summary to the aspect knowledge set. At block 312, based on comparing the concept summary to the aspect knowledge set, generate a gap analysis output that identifies one or more missing aspects associated with the aspect knowledge set of the item listing platform. At block 314, incorporate the one or more missing aspects into one or more features associated with the item listing platform.

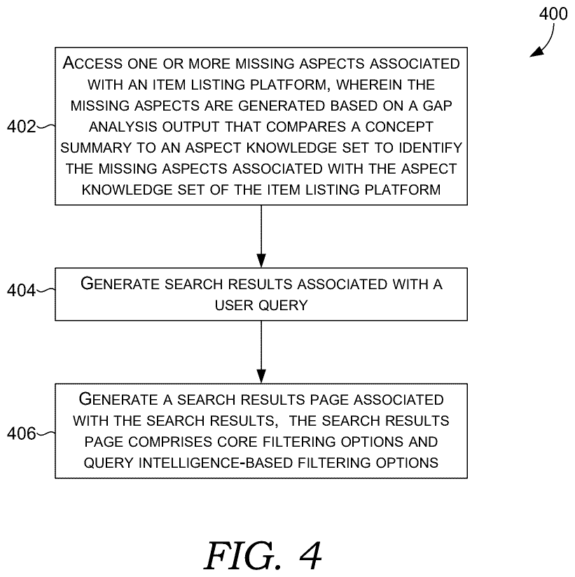

Turning to FIG. 4, a flow diagram is provided that illustrates a method 400 for providing alternate query generation in an artificial intelligence system. At block 402, access one or more missing aspects associated with an item listing platform, wherein the one or more missing aspects are generated based on a gap analysis output that compares a concept summary to an aspect knowledge set to identify the one or more missing aspects associated with the aspect knowledge set of the item listing platform. At block 404, generate search results associated with a user query. At block 406, generate a search results page associated with the search results, wherein the search results page comprises core filtering options and query intelligence-based filtering options, wherein the core filtering options are predefined filtering operations based on structured aspects of one or more items of the item listing platform, and wherein the query intelligence-based filtering options are based on the one or more missing aspects.

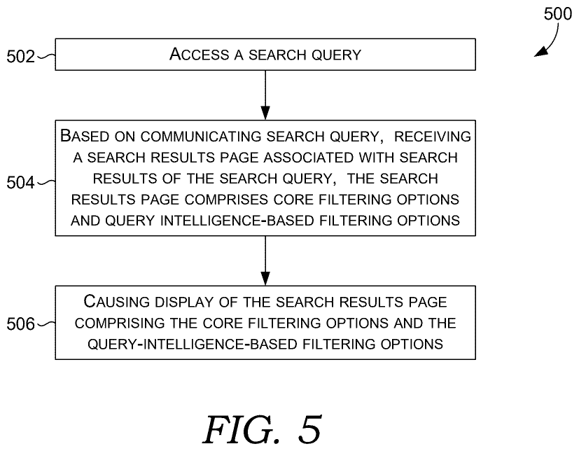

Turning to FIG. 5, a flow diagram is provided that illustrates a method 500 for providing alternate query generation in an artificial intelligence system. At block 502, access a search query. At block 504, based on communicating the search query, receive a search results page associated with search results of the search query, the search results page comprising core filtering options and query intelligence-based filtering options, wherein the core filtering options are predefined filtering operations based on structured aspects of one or more items of an item listing platform, and wherein the query intelligence-based filtering options are based on one or more missing aspects. At block 506, cause display of the search results page comprising the core filtering options and the query intelligence-based filtering options.

### Technical Improvement

Embodiments of the present invention have been described with reference to several inventive features (e.g., operations, systems, engines, and components) associated with an item listing system. Inventive features described include operations, interfaces, data structures, and arrangements of computing resources associated with providing the functionality described herein relative with reference to a query management engine associated with an artificial intelligence system.

Embodiments of the present invention relate to the field of computing, and more particularly to an item listing system. The following described exemplary embodiments provide a system, method, and program product to, among other things, execute item listing system operations that provide a query management engine. Therefore, the present embodiments improve the technical field of artificial intelligence technology and item listing platform technology enhancing the efficiency and effectiveness of query management.

The query intelligence engine operates through a focused sequence of steps that enable dynamic enhancement of structured e-commerce metadata. First, a set of underperforming or high-traffic search queries is extracted from user behavior data. These queries are then processed by a Large Language Model (LLM), which generates a concept-level annotation of each query. The LLM identifies relevant product-related terms and organizes them into structured conceptual buckets. In parallel, a structured aspect knowledge base is consulted to determine which attributes are already represented in the platform's taxonomy. The next operation involves mapping LLM-generated concepts to this structured aspect system using a combination of string matching and aspect value correlation. Finally, the query intelligence compares the two resulting sets—LLM concepts and structured aspects—to identify gaps or mismatches. These “missing aspects” are then surfaced for integration into the search interface or product listing logic to improve relevance and user engagement.

Advantageously, the query intelligence engine introduces several concrete technical improvements to item listing system technology. First, it improves computer functionality by enabling automated correction of incomplete or imprecise metadata mappings using a machine-learned output aligned with a structured taxonomy, reducing reliance on manual tagging. Second, it enhances the precision of e-commerce search engines by integrating a semantic enrichment process that identifies and supplements missing product attributes—producing more relevant search results and improving system performance under constrained vocabularies. Third, the query intelligence engine introduces a non-conventional method for reconciling structured and unstructured data: it maps noisy, open-ended LLM outputs to rigid platform taxonomies using a multi-phase alignment process based on string overlap, value frequency, and semantic inference. This transformation of loosely structured language into actionable, system-compatible input demonstrates more than abstract idea execution—it reflects a specific improvement in how computers process language data to serve practical e-commerce use cases efficiently and at scale.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing platform operations 630 and item listing platform interfaces 640. The item listing platform operations 630 can include service operations, communication operations, resource management operations, security operations, and fault tolerance operations that support specific tasks or functions in the item listing platform 610. The item listing platform interfaces 640 can include service interfaces, communication interfaces, resource interfaces, security interfaces, and management and monitoring interfaces that support functionality between the item listing platform components. The item listing platform operations 630 and item listing platform interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing query management engine's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

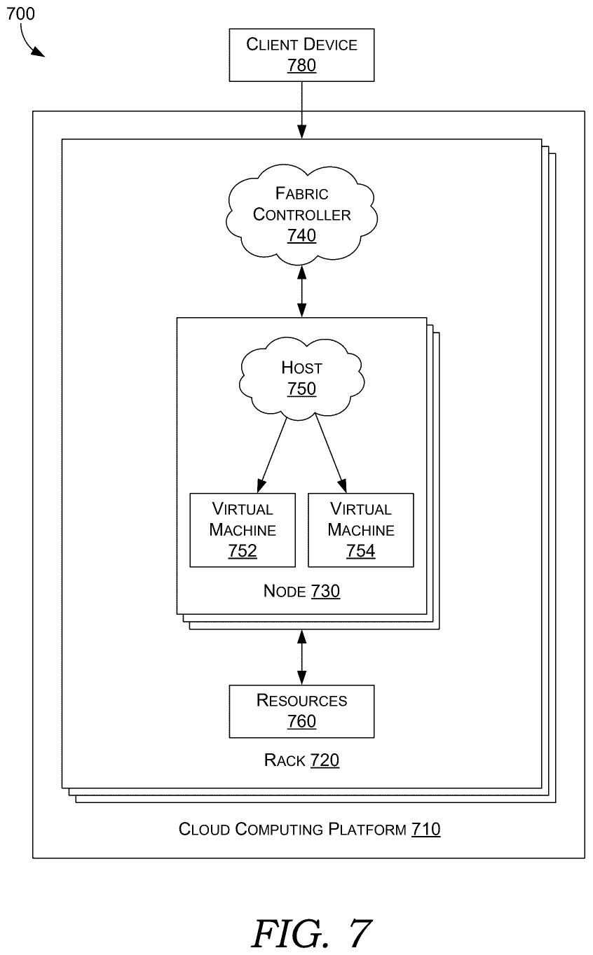

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

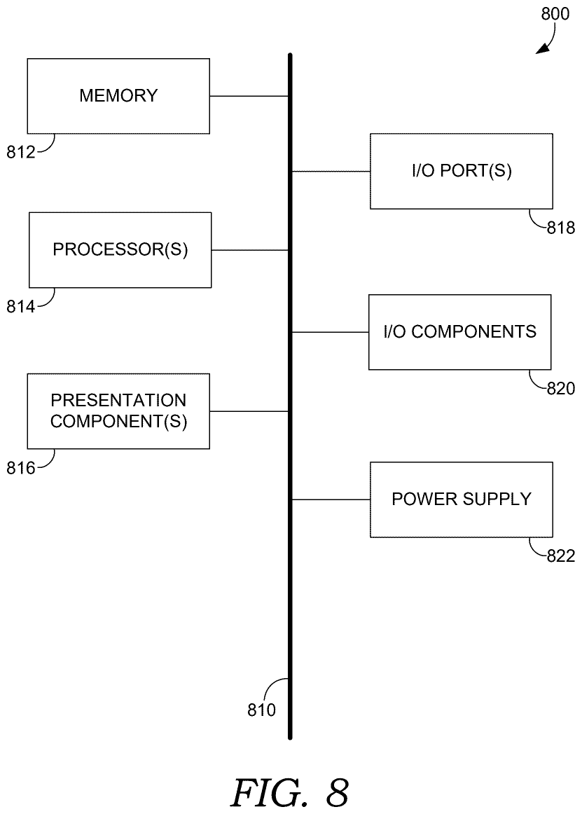

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computer-implemented method, the method comprising:
accessing historical queries;
using a Large Language Model (LLM), determining conceptual-category annotations based on semantic information associated with the historical queries;
based on the conceptual-category annotations, generating a concept summary comprising the conceptual-category annotations of the historical queries;
generating an aspect knowledge set based on query-level matching and item-level matching that identify aspects associated with one or more items in an item listing platform;
comparing the concept summary to the aspect knowledge set;
based on comparing the concept summary to the aspect knowledge set, generating a gap analysis output that identifies one or more missing aspects associated with the aspect knowledge set of the item listing platform; and
incorporating the one or more missing aspects into one or more features associated with the item listing platform.

2. The computer-implemented method of claim 1, wherein the historical queries include top-searched queries and non-converting queries, wherein a top-searched query includes most popular search terms of the item listing platform, and wherein a non-converting query includes search terms that do not lead to conversions.

3. The computer-implemented method of claim 1, wherein a conceptual-category annotation is a label assigned to key concepts from the historical queries that support categorizing the historical queries into specific semantic groups.

4. The computer-implemented method of claim 1, wherein the conceptual-category annotations include general concepts, niche concepts, and trends and cultural influences.

5. The computer-implemented method of claim 1, wherein generating the aspect knowledge set comprises:
comparing the historical queries with attributes or specifications of a plurality of items in the item listing platform;
identifying the one or more items in the item listing platform that match the historical queries; and
generating the aspect knowledge set based on aspects associated with the one or more items.

6. The computer-implemented method of claim 1, wherein the one or more features of the item listing platform include a search results page, wherein the one or more missing aspects are provided as derived aspects.

7. The computer-implemented method of claim 1, wherein the one or more missing aspects are provided as derived aspects that support filtering a plurality of items associated with the item listing platform.

8. One or more computer-storage media having computer-executable instructions embodied thereon that, when executed by a computing system having a processor and memory, cause the processor to perform operations, the operations comprising:
accessing one or more missing aspects associated with an item listing platform, wherein the one or more missing aspects are generated based on a gap analysis output that compares a concept summary to an aspect knowledge set to identify the one or more missing aspects associated with the aspect knowledge set of the item listing platform;
generating search results associated with a user query;
generating a search results page associated with the search results, wherein the search results page comprises core filtering options and query intelligence-based filtering options, wherein the core filtering options are predefined filtering operations based on structured aspects of one or more items of the item listing platform, and wherein the query intelligence-based filtering options are based on the one or more missing aspects.

9. The media of claim 8, wherein the concept summary is generated using a large language model (LLM) configured to generate the concept summary comprising conceptual-category annotations of historical queries.

10. The media of claim 9, wherein the historical queries include top-searched queries and non-converting queries, wherein a top-searched query includes most popular search terms of the item listing platform, and wherein a non-converting query includes search terms that do not lead to conversions.

11. The media of claim 9, wherein a conceptual-category annotation is a label assigned to key concepts from the historical queries that support categorizing the historical queries into specific semantic groups.

12. The media of claim 8, wherein the aspect knowledge set is generated based on query-level matching and item-level matching that identify aspects associated with one or more items in the item listing platform.

13. The media of claim 8, wherein the query intelligence-based filtering options are dynamically generated in real-time based on the one or more missing aspects and are displayed alongside the core filtering options on the search results page.

14. The media of claim 8, the operations further comprising presenting an interactive filtering interface that enables a user to refine the search results using both the core filtering options and the query intelligence-based filtering options.

15. A computerized system comprising:
one or more computer processors; and
computer memory storing computer-useable instructions that, when used by the one or more computer processors, cause the one or more computer processors to perform operations, the operations comprising:
accessing a search query;
based on communicating the search query, receiving a search results page associated with search results of the search query, the search results page comprising core filtering options and query intelligence-based filtering options,
wherein the core filtering options are predefined filtering operations based on structured aspects of one or more items of an item listing platform, and wherein the query intelligence-based filtering options are based on one or more missing aspects; and
causing display of the search results page comprising the core filtering options and the query intelligence-based filtering options.

16. The system of claim 15, wherein the one or more missing aspects are generated based on a gap analysis output that compares a concept summary to an aspect knowledge set to identify the one or more missing aspects associated with the aspect knowledge set of the item listing platform.

17. The system of claim 16, wherein the concept summary is generated using a large language model (LLM) configured to generate the concept summary comprising conceptual-category annotations of historical queries.

18. The system of claim 16, wherein the aspect knowledge set is generated based on query-level matching and item-level matching that identify aspects associated with one or more items in the item listing platform.

19. The system of claim 15, wherein the query intelligence-based filtering options are dynamically generated in real-time based on the one or more missing aspects and are displayed alongside the core filtering options on the search results page.

20. The system of claim 15, the operations further comprising presenting an interactive filtering interface that enables a user to refine the search results using both the core filtering options and the query intelligence-based filtering options.
